(19) United States
(12) Patent Application Publication
(10) Pub. No.: US 2025/0054090 A1
(43) Pub. Date: Feb. 13, 2025

(54) METHOD FOR DISPLAYING CONTENT OF MOBILITY BY IDENTIFICATION OF RIDING TARGET, AND APPARATUS IMPLEMENTING THE SAME

(71) Applicant: MOTOV CO., LTD., Incheon (KR)

(72) Inventors: Seong Hoon KIM, Sejong-si (KR); Woo Hyeok LIM, Seoul (KR); Soon Beom KIM, Anyang-si (KR)

(73) Assignee: MOTOV CO., LTD., Incheon (KR)

(21) Appl. No.: 18/587,142

(22) Filed: Feb. 26, 2024

(30) Foreign Application Priority Data
Aug. 7, 2023 (KR) 10-2023-0102820

(51) Int. Cl. G06Q 50/47; G06F 3/14; G06V 10/70; G06V 20/58; G06V 40/10; H04W 4/80

(52) U.S. Cl. CPC G06Q 50/47; G06F 3/14; G06V 10/70; G06V 20/58; G06V 40/10; H04W 4/80

(57) ABSTRACT

A method for displaying content of a mobility by identification of a riding target, performed by a display device provided in the mobility is provided. The method may comprise determining whether the mobility dispatched according to a call request of a user has entered within a critical distance with respect to a location specified by the user and displaying content related to a riding target on a screen of the display device when the riding target registered by the user is identified using an image sensor mounted on the mobility, when it is determined that the mobility has entered within the critical distance, wherein the riding target and the user are different.

### CROSS-REFERENCE TO RELATED APPLICATION

This application claims priority from Korean Patent Application No. 10-2023-0102820 filed on Aug. 7, 2023 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for displaying content of a mobility by identification of a riding target and an apparatus for implementing the same, and more particularly to a method for displaying content of a mobility by identification of a riding target for the mobility to recognize the riding target and provide a safe riding service, and an apparatus for implementing the same.

### 2. Description of the Related Art

A service-type mobility, which provides various means of mobility necessary for people, such as taxis, designated drivers, and rental cars, on a platform, is being recently commercialized.

In particular, taxi call services, which are widely used, generally allow a user to directly call a taxi through an application installed on a mobile phone, and allow the taxi dispatched to the user through a platform server to move to a location where the user is located and allow the user to ride.

In this way, the existing taxi call service is provided under the assumption that the user calling the taxi and the passenger riding the taxi are the same.

When people with transportation disabilities, such as young children, elderly parents, or the disabled, need to use the taxi call service, people with transportation disabilities may use the taxi using a method in which a guardian calls the taxi on behalf of a ward, who is people with transportation disabilities, at the same location as the ward.

However, if the guardian is located far away from the ward, a service that may call a taxi to a ward's location is not provided. Moreover, even if a riding location may be set to a location where the ward is located, it is not easy to use the taxi call service due to concerns about whether the taxi may accurately reach the ward and safety issues for the ward.

Therefore, there is a need to provide a service that allows the guardian to safely call the taxi or use a pick-up function for the wards, such as young children, elderly parents, or the disabled, even at remote sites. In addition, when calling the taxi for the ward at the remote site, it is required to provide personally customized visual information so that the called taxi and the ward may recognize each other.

### SUMMARY

Aspects of the present disclosure provide a method for displaying content of a mobility by identification of a riding target that may provide a safe transportation service by moving the mobility to a location of the riding target registered by a caller when the caller of the mobility and the riding target are different, and an apparatus for implementing the same method.

Aspects of the present disclosure also provide a method for displaying content of a mobility by identification of a riding target that enables the mobility and the riding target to easily recognize each other by displaying customized content when the mobility accurately identifies the riding target registered by a caller when the caller of the mobility and the riding target are different, and an apparatus for implementing the same method.

Aspects of the present disclosure also provide a method for displaying content of a mobility by identification of a riding target that enables users to remotely use a call or pick-up service of the mobility for people with transportation disabilities such as young children, elderly parents, and the disabled and for guests visiting airports/terminals from overseas or distant places, and an apparatus for implementing the same method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for displaying content of a mobility by identification of a riding target, performed by a display device provided in the mobility. The method may comprise determining whether the mobility dispatched according to a call request of a user has entered within a critical distance with respect to a location specified by the user and displaying content related to a riding target on a screen of the display device when the riding target registered by the user is identified using an image sensor mounted on the mobility, when it is determined that the mobility has entered within the critical distance, wherein the riding target and the user are different.

In some embodiments, the determining of whether the mobility has entered within the critical distance may include activating a Bluetooth function of the mobility when it is determined that the mobility has entered within the critical distance with respect to the location specified by the user based on location information of the mobility and activating the image sensor when a terminal of wirelessly communicating data with the mobility through the Bluetooth function is recognized.

In some embodiments, the displaying of the content related to the riding target on the screen of the display device when the riding target registered by the user is identified may include scanning objects located on roads and sidewalks using a first camera mounted on a front of the mobility and a second camera mounted on a side surface of the mobility.

In some embodiments, the displaying of the content related to the riding target on the screen of the display device when the riding target registered by the user is identified may include scanning the objects using the first camera when the mobility has entered within a first critical distance with respect to the location specified by the user and scanning the objects using the second camera when the mobility has entered within a second critical distance with respect to the location specified by the user, the second critical distance is shorter than the first critical distance, and the second camera is a camera facing a sidewalk side.

In some embodiments, the displaying of the content related to the riding target on the screen of the display device when the riding target registered by the user is identified may include identifying an object corresponding to an object image and text information registered by the user among the objects scanned using the image sensor, as the riding target, and the text information includes information about an appearance and clothing of the riding target.

In some embodiments, the identifying of the object corresponding to the object image and text information registered by the user among the objects scanned using the image sensor, as the riding target may include outputting an identification result of the riding target by inputting the object image and text information into an object recognition model based on an artificial intelligence algorithm.

In some embodiments, the displaying of the contents related to the riding target on the screen of the display device may include displaying riding target display information preset by the user on the screen in response to the riding target being identified.

In some embodiments, the displaying of the riding target display information preset by the user on the screen may include displaying a notification message including at least portion of profile information of the riding target registered by the user on the screen.

In some embodiments, the displaying of the contents related to the riding target on the screen of the display device may include transmitting arrival notification information to a terminal of the user in response to the riding target being identified and transmitting riding notification information to the terminal of the user in response to the riding of the riding target being completed.

In some embodiments, the displaying of the contents related to the riding target on the screen of the display device may include transmitting arrival information of the mobility to a terminal of the riding target to be displayed through a push notification of an application, when the application for providing a service of the mobility is installed on the terminal of the riding target.

In some embodiments, the displaying of the contents related to the riding target on the screen of the display device may include executing an automatic dialing to the terminal of the riding target when the application for providing the service of the mobility is not installed on the terminal of the riding target and transmitting arrival information of the mobility to the terminal of the riding target to be displayed on a screen of the terminal of the riding target, when the display device is connected to the terminal of the riding target through the automatic dialing.

According to another aspect of the present disclosure, there is provided a display device provided in a mobility. The display device may comprise a network interface configured to communicate with an external device, a display configured to display an image, one or more processors, a memory configured to load a computer program executed by the processor and a storage configured to store the computer program, wherein the computer program includes instructions for performing: an operation of determining whether the mobility dispatched according to a call request of a user has entered within a critical distance with respect to a location specified by the user and an operation of displaying content related to a riding target on a screen of the display device when the riding target registered by the user is identified using an image sensor mounted on the mobility, when it is determined that the mobility has entered within the critical distance, and the riding target and the user are different.

In some embodiments, the operation of determining of whether the mobility has entered within the critical distance may include an operation of activating a Bluetooth function of the mobility when it is determined that the mobility has entered within the critical distance with respect to the location specified by the user based on location information of the mobility and an operation of activating the image sensor when a terminal of wirelessly communicating data with the mobility through the Bluetooth function is recognized.

In some embodiments, the operation of displaying of the content related to the riding target on the screen of the display device when the riding target registered by the user is identified may include an operation of scanning objects located on roads and sidewalks using a first camera mounted on a front of the mobility and a second camera mounted on a side surface of the mobility.

In some embodiments, the operation of displaying of the content related to the riding target on the screen of the display device when the riding target registered by the user is identified may include an operation of scanning the objects using the first camera when the mobility has entered within a first critical distance with respect to the location specified by the user and an operation of scanning the objects using the second camera when the mobility has entered within a second critical distance with respect to the location specified by the user, the second critical distance is shorter than the first critical distance, and the second camera is a camera facing a sidewalk side.

In some embodiments, the operation of displaying of the content related to the riding target on the screen of the display device when the riding target registered by the user is identified may include an operation of identifying an object corresponding to an object image and text information registered by the user among the objects scanned using the image sensor, as the riding target, and the text information includes information about an appearance and clothing of the riding target.

In some embodiments, the operation of identifying of the object corresponding to the object image and text information registered by the user among the objects scanned using the image sensor, as the riding target may include an operation of outputting an identification result of the riding target by inputting the object image and text information into an object recognition model based on an artificial intelligence algorithm.

In some embodiments, the operation of displaying of the contents related to the riding target on the screen of the display device may include an operation of displaying riding target display information preset by the user on the screen in response to the riding target being identified.

In some embodiments, the operation of displaying of the riding target display information preset by the user on the screen may include an operation of displaying a notification message including at least portion of profile information of the riding target registered by the user on the screen.

In some embodiments, the operation of displaying of the contents related to the riding target on the screen of the display device may include an operation of transmitting arrival notification information to a terminal of the user in response to the riding target being identified and an operation of transmitting riding notification information to the terminal of the user in response to the riding of the riding target being completed.

### BRIEF DESCRIPTION OF THE DRAWINGS

The above and other aspects and features of the present disclosure will become more apparent by describing in detail exemplary embodiments thereof with reference to the attached drawings, in which:

FIG. 1 illustrates a configuration of a system for performing a method for displaying content of a mobility by identification of a riding target according to an exemplary embodiment;

FIG. 2 is a flowchart for describing a method for displaying content of a mobility by identification of a riding target performed by a display device included in the mobility according to an exemplary embodiment;

FIGS. 3 to 5 are flowcharts for describing detailed processes of some steps illustrated in FIG. 2;

FIG. 6 is an example of scanning an object using a front camera and a side camera mounted on the mobility according to some exemplary embodiments of the present disclosure;

FIG. 7 is an example of primary scanning with a front camera and then secondary scanning with a side camera according to the remaining distance to a riding location according to some exemplary embodiments of the present disclosure;

FIG. 8 is an example of registering an object image and text information of a riding target on a server in a user terminal according to some exemplary embodiments of the present disclosure;

FIG. 9 is an example of outputting an identification result of the riding target using an AI-based object recognition model according to some exemplary embodiments of the present disclosure;

FIG. 10 is an example of displaying riding target display information in various forms on a screen when identifying the riding target according to some exemplary embodiments of the present disclosure; and

FIG. 11 is a hardware configuration diagram of an exemplary computing device capable of implementing the methods according to an exemplary embodiment of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

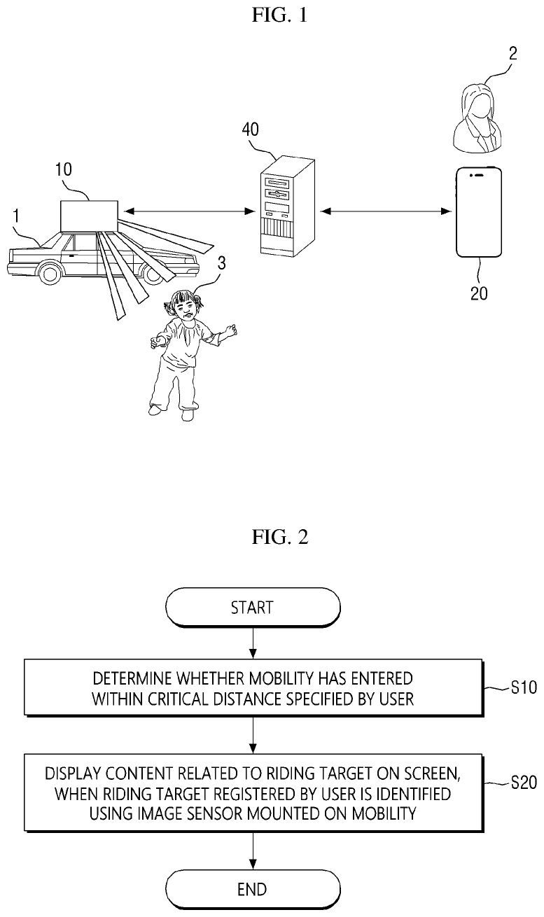

FIG. 1 illustrates a configuration of a system for performing a method for displaying content of a mobility by identification of a riding target according to an exemplary embodiment. Referring to FIG. 1, a system according to an exemplary embodiment of the present disclosure includes a display device 10 provided in a mobility 1 and a server 40, and the display device 10 is connected to the server 40 through a network. The server 40 may be connected to a user terminal 20 through a network.

The mobility 1 may be, for example, a means of transportation such as a taxi, call van, demand-responsive transportation (DRT), academy vehicle, shuttle bus, and rental car. The display device 10 provided in the mobility 1 may be, for example, a digital signage for outdoor advertising, a digital TV, a large display (LFD), and a monitor.

The display device 10 may be installed at an upper end of the mobility 1 to facilitate identification from various directions. The form in which the display device 10 is installed on the mobility 1 is not limited by the exemplary embodiments of the present disclosure, and the display device 10 may also be installed on the side, or front and rear of the mobility 1 considering the purpose of installation of the display device 10 and the structure of the mobility 1.

The user terminal 20 may be, for example, any one of mobile computing devices such as a smart phone, a tablet PC, a laptop PC, a PDA, a virtual reality (VR) imaging device, and an augmented reality (AR) imaging device.

The server 40 is a device that transmits and receives data for providing a mobility call service according to a request of the user terminal 20 and provides information related to content to be displayed on the display device 10 provided in the mobility 1, and may be a stationary computing device, such as a server system or a PC. The server 40 may be connected to a plurality of user terminals 20, a plurality of display devices 10 provided in a plurality of mobilities 1, and a plurality of driver terminals (not illustrated) through a network. The server 40 may be implemented as a web server that processes responses to HTTP requests from a web browser of the user terminal 20 and the driver terminal, and a WAS server that may process dynamic content or web application services and interface with databases. As an example, the WAS server may also include a functionality of the web server.

The server 40 may perform dispatch of an available mobility 1 among the plurality of mobilities in response to a mobility call or reservation request from the user terminal 20, and may transmit information indicating that the mobility 1 has been dispatched to the user terminal 20 and the display device 10 of the mobility 1. In this case, the server 40 may receive, from the user terminal 20, information about a riding target 3 input from the user terminal 20, information about a riding location where the riding subject 3 will ride and arrival location, profile information of the user 2, and profile information and photo images of the riding target 3, etc., and may use such information to dispatch the available mobility 1 to the user terminal 20. In this case, the user 2 and the riding target 3 may be different, and the user 2 and the riding target 3 may be separated by a preset distance or more. Here, the riding target 3 is a ward of the user 2, and may be, for example, young children, elderly parents, or the disabled. In addition, the riding target 3 may be a guest of the user 2 that visits the airport/terminal from, for example, a foreign country or a distant region.

As described above, if the dispatch of the mobility 1 is completed, the display device 10 provided in the dispatched mobility 1 determines whether the mobility 1 has entered within a critical distance with respect to a location of the riding target 3 input by the user 20 according to the movement of the mobility 1.

When it is determined that the mobility 1 has entered within the critical distance with respect to the location of the riding target 3, the display device 10 scans the riding target 3 using an image sensor mounted on the mobility 1. When the riding target 30 is identified through the scanning, the display device 10 displays content related to the riding target 3 on a screen of the display device 10.

In this case, the content may be portion of profile information on the riding target 3 registered in advance from the user terminal 20 to the server 40. As an example, the display device 10 may display a portion of the name, nickname, or contact information of the riding target 3 on the screen. The content displayed on the screen of the display device 10 is not limited to the exemplary embodiment, and may be displayed in various forms such as text, symbols, and images input from the user terminal 20.

In addition, the information input from the user terminal 20 in relation to the content displayed on the screen of the display device 10 may be transmitted to the terminal of the riding target 3 so that the riding target 3 may confirm the information.

As described above, according to the configuration of the system according to the exemplary embodiment of the present disclosure, when the user 2 who called the mobility 1 and the riding target 3 are different, the mobility 1 may move to the location of the riding target 3 and provide a safe transportation service. In addition, the display device 10 of the mobility 1 may provide customized content so that the mobility 1, which has moved according to a call from the user 2, may easily recognize the riding target 3.

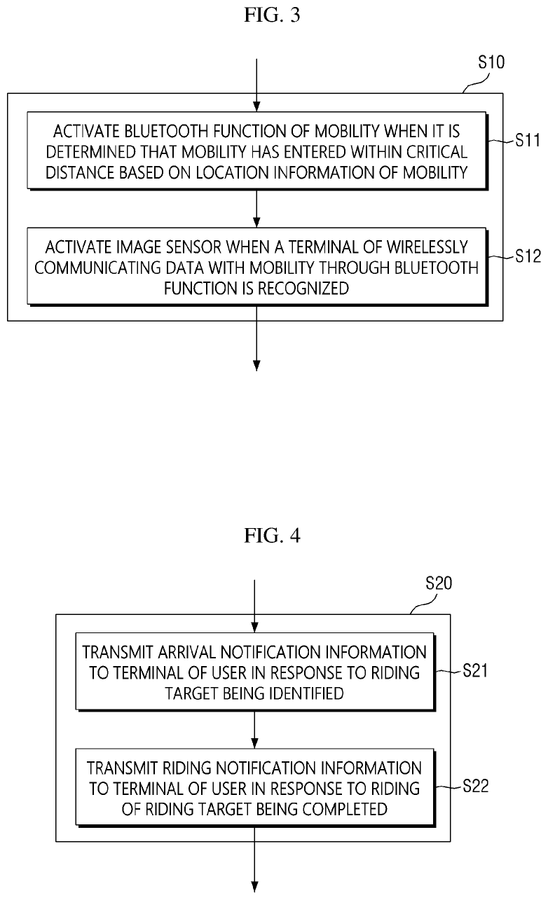

FIG. 2 is a flowchart for describing a method for displaying content of a mobility by identification of a riding target performed by a display device included in the mobility according to an exemplary embodiment.

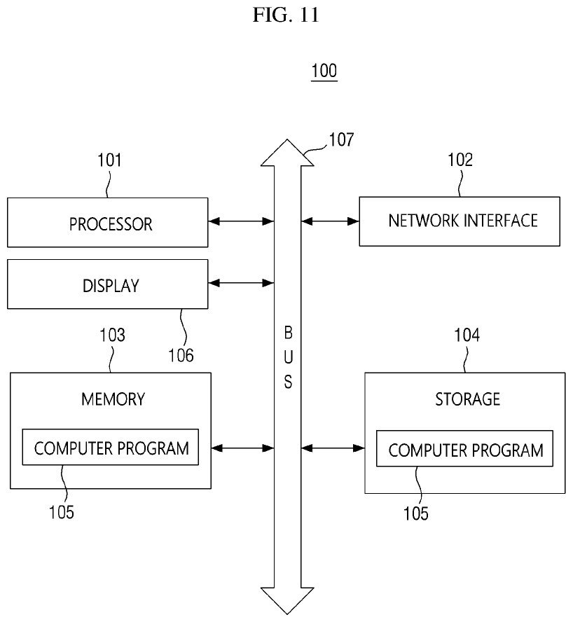

The method for displaying content of a mobility by identification of a riding target according to the exemplary embodiment of the present disclosure may be performed by the display device 10 included in the mobility 1 illustrated in FIG. 1. The display device 10 may be, for example, a computing device 100 illustrated in FIG. 11.

It should be noted that description of a subject performing some operations included in the method according to the exemplary embodiment of the present disclosure may be omitted, and in such case, the subject is the display device 10.

Referring to FIG. 2, first, in operation S10, the display device 10 determines whether the mobility 1 dispatched according to a mobility call request from the user terminal 20 has entered within a critical distance with respect to the location of the riding target 3 designated by the user 2 in the user terminal 20. In this case, the riding target 3 and the user 2 may be different and may be each located at locations separated by a preset distance or more.

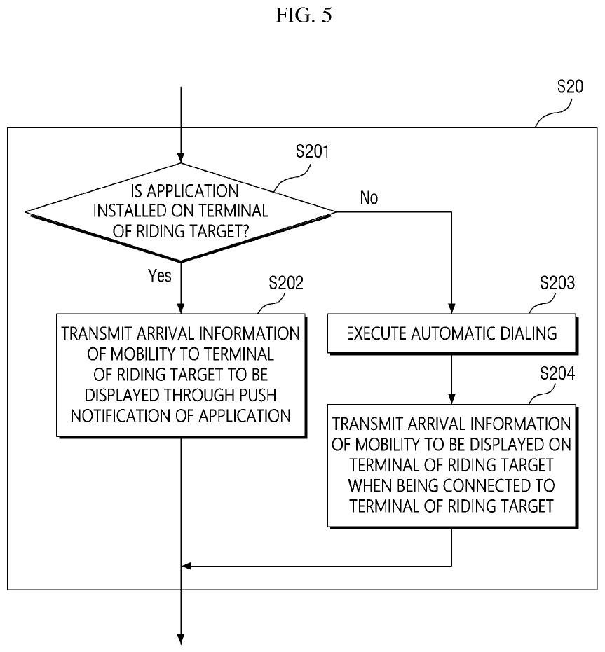

As an exemplary embodiment, referring to FIG. 3, the display device 10 may activate a Bluetooth function of the mobility 1 (operation S11) when it is determined that the mobility 1 has entered within the critical distance with respect to the location specified by the user 2 based on location information of the mobility 1 in operation S10, and may activate an image sensor when a terminal capable of wirelessly communicating data with the mobility 1 through the Bluetooth function is recognized (operation S12). Here, the image sensor may be mounted on the outside of the mobility 1 or on the outside of the display device 10.

According to the exemplary embodiment, in order to prevent an increase in system load resulting from continuously performing identification operations on all objects detected by the image sensor while the mobility 1 is moving, the identification operation of the riding target 3 may be started when approaching the location where the riding target 3 is located.

As another example, the display device 10 may selectively store images captured in a state in which the image sensor is always activated. For example, when the mobility 1 has entered within the critical distance with respect to the location specified by the user 2, the display device 10 may start an operation of storing and identifying the images captured by the image sensor.

Next, in operation S20 of FIG. 2, if is determined that the mobility 1 has entered within the critical distance with respect to the location specified by the user 2, the display device 10 displays contents related to the riding target 3 on the screen of the display device 10 when the riding target registered by the user 2 is identified using the image sensor mounted on the outside of the mobility 1 or the outside of the display device 10.

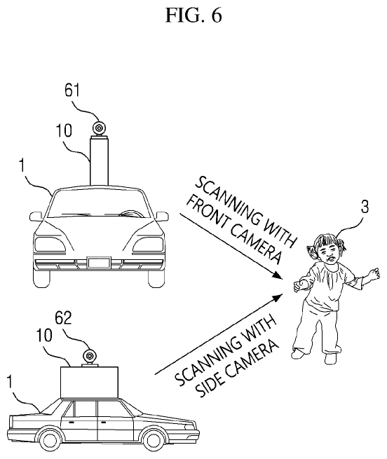

As an example, as illustrated in FIG. 6, the display device 10 may scan objects located on roads and sidewalks using a first camera 61 mounted on the front of the mobility 1 and a second camera 62 mounted on the side surface of the mobility 1. Here, the first camera 61 and the second camera 62 may be mounted on the outside of the mobility 1 or the outside of the display device 10. According to the exemplary embodiment, while the mobility 1 moves to the location where the riding target 3 registered by the user 2 is located, the display device 10 may perform a more precise scanning operation for identifying the riding target 3 among the objects located on the roads or sidewalks using both cameras installed on the front and side of the mobility 1.

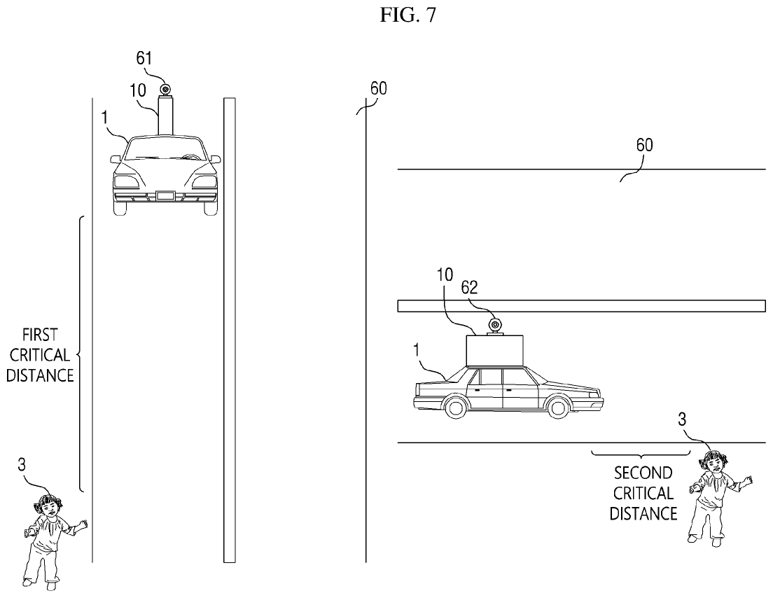

As an example, as illustrated in FIG. 7, when the mobility 1 has entered within a first critical distance with respect to the location specified by the user 2, the display device 10 may scan objects located on roads and sidewalks using the first camera 61 mounted on the front of the mobility device 1.

In addition, when the mobility 1 has entered within a second critical distance with respect to the location specified by the user 2 while the display device 10 scans the objects using the first camera 61, the display device 10 may scan objects located on the sidewalks using the second camera 62 mounted on the side of the mobility device 1. In this case, the second critical distance may be shorter than the first critical distance, the first camera 61 may be a camera facing the front, and the second camera 62 may be a camera facing the sidewalk side (e.g., right side).

As an example, the display device 10 may initially scan the objects using only the first camera 61 facing the front when the mobility 1 is dispatched and departs for the location where the riding target 3 is located, and may then scan the objects using both the first camera 61 and the second camera 62 facing the sidewalk side when the mobility 1 approaches the location where the riding target 3 is located. As another example, the display device 10 may also perform a scanning operation using only the second camera 62 instead of the first camera 61 when approaching the location where the riding target 3 is located. Accordingly, accuracy may be improved in identifying the riding target 3 by performing the scanning using the second camera 62 toward the sidewalk side, where the riding target is likely to be standing, as the mobility approaches the location of the riding target 3.

As an exemplary embodiment, the display device 10 may identify an object corresponding to an object image and text information registered by the user 2 among the objects scanned using the image sensor while the mobility 1 moves to the location where the riding target 3 is located, as the riding target 3.

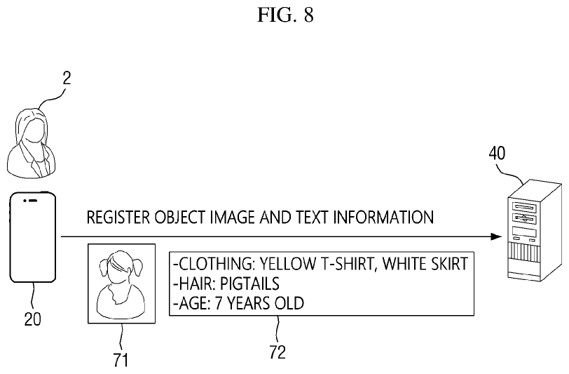

As an example, as illustrated in FIG. 8, an object image 71 and text information 72 about the riding target 3 input by the user 2 from the user terminal 20 may be registered and stored in the server 40, and an object with high similarity to the object image 71 and text information 72 registered in the server 40 among the objects scanned by the image sensor may be identified as the riding target 3. Here, the object image 71 may be, for example, a face photo image, an upper body photo image, or a full body photo image of the riding target 3. The text information 72 may be, for example, letter or numeric information that records at least one of the appearance, clothing, age group, gender, and special information of the riding target 3.

According to the exemplary embodiment, when calling the mobility 1, the riding target 3 may be easily identified among the objects scanned based on the image and various information about the riding target 3 registered by the user 2.

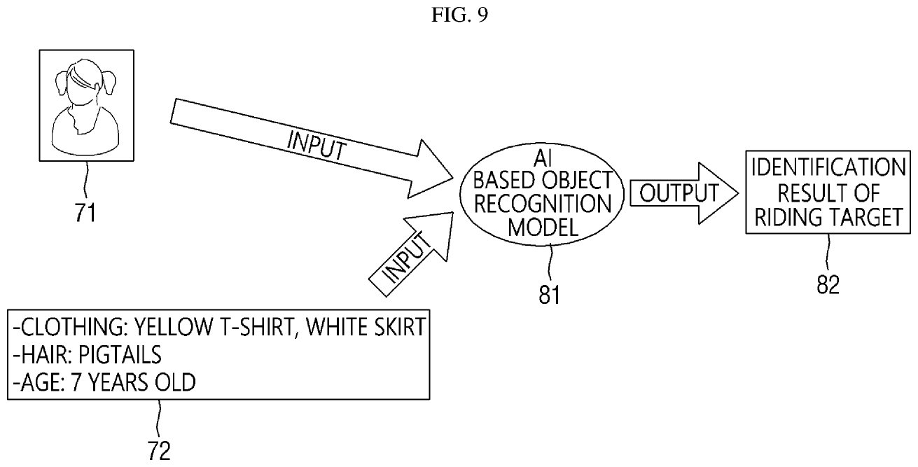

As an exemplary embodiment, as illustrated in FIG. 9, the display device 10 may output an identification result 82 of the riding target 3 by inputting the object image 71 and text information 72 into an object recognition model 81 based on an artificial intelligence algorithm. Here, the object recognition model 81 may be, for example, a vision language model (VLM), which is a deep learning model that simultaneously processes photos, images, and text. Accordingly, the display device 10 may identify the riding target 3 with high accuracy by utilizing a vision-language based ultra-large AI model such as VLM and Edge AI technology that may locally execute AI algorithms.

As an exemplary embodiment, the display device 10 may display riding target display information preset by the user 2 on the screen in response to the riding target 3 being identified.

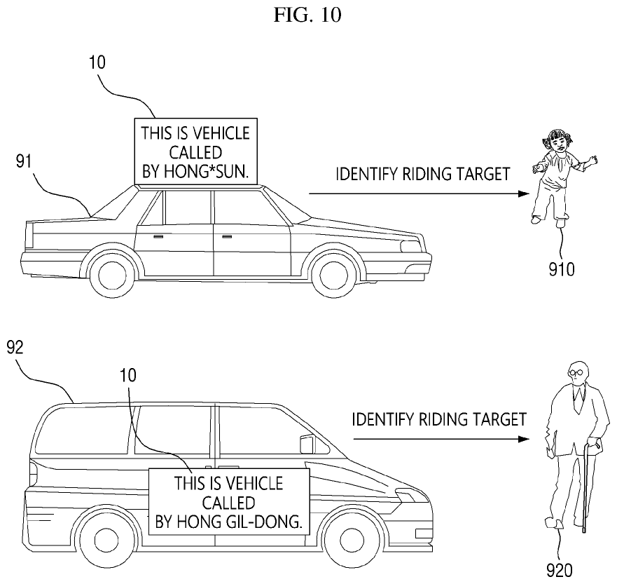

As an example, as illustrated in FIG. 10, when a riding target 910 is a child, the display device 10 may display a portion of the child's name on the screen as soon as the child is identified by the image sensor. As another example, when a riding target 920 is an elderly person with impaired mobility, the display device 10 may display the full name of the elderly person on the screen as soon as the elderly person is identified by the image sensor.

As described above, the riding target 3 may easily check whether a vehicle called by his or her guardian is correct through the information displayed on the screen of the display device 10 by the display device 10 displaying all or portion of the profile information, such as name and nickname, of the child/elderly registered when the guardian calls the mobility 1, on the screen, at the time the display device 10 identifies the child/elderly person who is the riding target 3. Accordingly, the riding target 3 may accurately check the mobility 1 called by the guardian and ride the mobility 1 with confidence.

As an exemplary embodiment, as illustrated in FIG. 4, the operation S20 may include operation S21 and operation S22 as detailed operations.

In operation S21, the display device 10 may transmit arrival notification information to the user terminal 20 in response to the riding target 3 being identified. In this case, the arrival notification information may be transmitted not only to the user terminal 20 but also to the terminal of the riding target 3.

Subsequently, in operation S22, the display device 10 may transmit riding notification information to the user terminal 20 in response to the riding of riding of the riding target 3 being completed. In this case, the arrival notification information and the riding notification information transmitted to the user terminal 20 may be provided through an application installed on the user terminal 20.

According to the exemplary embodiment, by providing notification information to the user 2 at the time when the mobility 1 dispatched according to the mobility call of the user 2 discovers the riding target 3 and the time when the riding target 3 rides the mobility 1, respectively, the user 2 may easily check that the riding target 3 has safely rode through his or her mobile device or an application installed on the mobile device.

As an exemplary embodiment, as illustrated in FIG. 5, the operation S20 may include operation S201 to operation S204 as detailed operations.

In operation S201, the display device 10 may determine whether an application for a mobility calling service is installed on the terminal of the riding target 3.

If the application is installed as a result of the determination in operation S201, in operation S202, the display device 10 may transmit arrival information of the mobility 1 to the terminal of the riding target 3 to be displayed through a push notification of the application.

If the application is not installed as a result of the determination in operation S201, in operation S203, the display device 10 may execute an automatic dialing to the terminal of the riding target 3. Subsequently, in operation S204, when the display device 10 is connected to the terminal of the riding target 30 through the automatic dialing, the display device 10 may transmit the arrival information of the mobility 1 to the terminal of the riding target 3 to be displayed on the screen of the terminal of the riding target 3.

According to the exemplary embodiment, depending on whether the application for the mobility call service is installed on the terminal of the riding target 3, it may be notified of the arrival of the mobility 1 in the most effective way through the application's push notification function or automatic dialing function.

FIG. 11 is a hardware configuration diagram of an exemplary computing device capable of implementing methods according to some exemplary embodiments of the present disclosure. As illustrated in FIG. 11, a computing device 100 may include one or more processors 101, a display 106, a bus 107, a network interface 102, a memory 103 for loading a computer program 105 performed by the processor 101, and a storage 104 for storing the computer program 105. However, only the components related to the exemplary embodiments of the present disclosure are illustrated in FIG. 11. Accordingly, those skilled in the art to which the present disclosure pertains may know that other general-purpose components other than the components illustrated in FIG. 11 may be further included.

The computing device 100 may be the display device 10 provided in the mobility device 1 as illustrated in FIG. 1.

The processor 101 controls the overall operation of each component of the computing device 100. The processor 101 may be configured to include at least one of a central processing unit (CPU), a micro processor unit (MPU), a micro controller unit (MCU), a graphic processing unit (GPU), or any type of processor well known in the art. In addition, the processor 101 may perform a calculation on at least one application or program for executing the methods/operations according to various exemplary embodiments of the present disclosure. The computing device 100 may include one or more processors.

The memory 103 stores various data, instructions, and/or information. The memory 103 may load one or more programs 104 from the storage 105 to execute the methods/operations according to various embodiments of the present disclosure. For example, when the computer program 105 is loaded into the memory 103, a logic (or module) may be implemented on the memory 103. An example of the memory 103 may be a RAM, but is not limited thereto.

The display 106 may display images based on image signals and various types of information received from external devices. The display 106 may be implemented in various forms, such as a plasma display panel (PDP), a liquid crystal display (LCD), an organic light emitting diodes (OLED), or a flexible display.

The bus 107 provides a communication function between the components of the computing device 100. The bus 107 may be implemented as various types of buses, such as an address bus, a data bus, and a control bus.

The network interface 102 supports wired/wireless Internet communications of the computing device 100. The network interface 102 may also support various communication methods other than Internet communication. To this end, the network interface 102 may be configured to include a communication module well known in the art of the present disclosure.

The storage 104 may non-temporarily store one or more computer programs 105.

The storage 104 may include a non-volatile memory such as a flash memory, a hard disk, a removable disk, or any type of computer-readable recording medium well known in the art to which the present disclosure belongs.

The computer program 105 may include one or more instructions in which the methods/operations according to various exemplary embodiments of the present disclosure are implemented. When the computer program 105 is loaded into the memory 103, the processor 101 may perform the methods/operations according to various embodiments of the present disclosure by executing the one or more instructions.

As an exemplary embodiment, the computer program 105 may include instructions for performing an operation of determining whether a mobility 1 dispatched according to a call request of a user has entered within a critical distance with respect to a location specified by the user, and an operation of displaying content related to a riding target on the display 106 when the riding target registered by the user is identified using an image sensor mounted on the mobility 1 if it is determined that the mobility 1 has entered within the critical distance. In this case, the riding target and the user may be different.

So far, a variety of embodiments of the present disclosure and the effects according to embodiments thereof have been mentioned with reference to FIGS. 1 to 11. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for displaying content of a mobility by identification of a riding target, performed by a display device provided in the mobility, the method comprising:
determining whether the mobility dispatched according to a call request of a user has entered within a critical distance with respect to a location specified by the user; and
displaying content related to a riding target on a screen of the display device when the riding target registered by the user is identified using an image sensor mounted on the mobility, when it is determined that the mobility has entered within the critical distance,
wherein the riding target and the user are different.

2. The method of claim 1, wherein the determining of whether the mobility has entered within the critical distance includes:
activating a Bluetooth function of the mobility when it is determined that the mobility has entered within the critical distance with respect to the location specified by the user based on location information of the mobility; and
activating the image sensor when a terminal of wirelessly communicating data with the mobility through the Bluetooth function is recognized.

3. The method of claim 1, wherein the displaying of the content related to the riding target on the screen of the display device when the riding target registered by the user is identified includes scanning objects located on roads and sidewalks using a first camera mounted on a front of the mobility and a second camera mounted on a side surface of the mobility.

4. The method of claim 3, wherein the displaying of the content related to the riding target on the screen of the display device when the riding target registered by the user is identified includes:
scanning the objects using the first camera when the mobility has entered within a first critical distance with respect to the location specified by the user; and
scanning the objects using the second camera when the mobility has entered within a second critical distance with respect to the location specified by the user,
the second critical distance is shorter than the first critical distance, and
the second camera is a camera facing a sidewalk side.

5. The method of claim 1, wherein the displaying of the content related to the riding target on the screen of the display device when the riding target registered by the user is identified includes identifying an object corresponding to an object image and text information registered by the user among the objects scanned using the image sensor, as the riding target, and
the text information includes information about an appearance and clothing of the riding target.

6. The method of claim 5, wherein the identifying of the object corresponding to the object image and text information registered by the user among the objects scanned using the image sensor, as the riding target includes outputting an identification result of the riding target by inputting the object image and text information into an object recognition model based on an artificial intelligence algorithm.

7. The method of claim 1, wherein the displaying of the contents related to the riding target on the screen of the display device includes displaying riding target display information preset by the user on the screen in response to the riding target being identified.

8. The method of claim 7, wherein the displaying of the riding target display information preset by the user on the screen includes displaying a notification message including at least portion of profile information of the riding target registered by the user on the screen.

9. The method of claim 1, wherein the displaying of the contents related to the riding target on the screen of the display device includes:
transmitting arrival notification information to a terminal of the user in response to the riding target being identified; and
transmitting riding notification information to the terminal of the user in response to the riding of the riding target being completed.

10. The method of claim 1, wherein the displaying of the contents related to the riding target on the screen of the display device includes transmitting arrival information of the mobility to a terminal of the riding target to be displayed through a push notification of an application, when the application for providing a service of the mobility is installed on the terminal of the riding target.

11. The method of claim 1, wherein the displaying of the contents related to the riding target on the screen of the display device includes:
executing an automatic dialing to the terminal of the riding target when the application for providing the service of the mobility is not installed on the terminal of the riding target; and
transmitting arrival information of the mobility to the terminal of the riding target to be displayed on a screen of the terminal of the riding target, when the display device is connected to the terminal of the riding target through the automatic dialing.

12. A display device provided in a mobility, the display device comprising:
a network interface configured to communicate with an external device;
a display configured to display an image;
one or more processors;
a memory configured to load a computer program executed by the processor; and
a storage configured to store the computer program,
wherein the computer program includes instructions for performing:
an operation of determining whether the mobility dispatched according to a call request of a user has entered within a critical distance with respect to a location specified by the user; and
an operation of displaying content related to a riding target on a screen of the display device when the riding target registered by the user is identified using an image sensor mounted on the mobility, when it is determined that the mobility has entered within the critical distance, and
the riding target and the user are different.

13. The display device of claim 12, wherein the operation of determining of whether the mobility has entered within the critical distance includes:
an operation of activating a Bluetooth function of the mobility when it is determined that the mobility has entered within the critical distance with respect to the location specified by the user based on location information of the mobility; and
an operation of activating the image sensor when a terminal of wirelessly communicating data with the mobility through the Bluetooth function is recognized.

14. The display device of claim 12, wherein the operation of displaying of the content related to the riding target on the screen of the display device when the riding target registered by the user is identified includes an operation of scanning objects located on roads and sidewalks using a first camera mounted on a front of the mobility and a second camera mounted on a side surface of the mobility.

15. The display device of claim 14, wherein the operation of displaying of the content related to the riding target on the screen of the display device when the riding target registered by the user is identified includes:
an operation of scanning the objects using the first camera when the mobility has entered within a first critical distance with respect to the location specified by the user; and
an operation of scanning the objects using the second camera when the mobility has entered within a second critical distance with respect to the location specified by the user,
the second critical distance is shorter than the first critical distance, and
the second camera is a camera facing a sidewalk side.

16. The display device of claim 12, wherein the operation of displaying of the content related to the riding target on the screen of the display device when the riding target registered by the user is identified includes an operation of identifying an object corresponding to an object image and text information registered by the user among the objects scanned using the image sensor, as the riding target, and
the text information includes information about an appearance and clothing of the riding target.

17. The display device of claim 16, wherein the operation of identifying of the object corresponding to the object image and text information registered by the user among the objects scanned using the image sensor, as the riding target includes an operation of outputting an identification result of the riding target by inputting the object image and text information into an object recognition model based on an artificial intelligence algorithm.

18. The display device of claim 12, wherein the operation of displaying of the contents related to the riding target on the screen of the display device includes an operation of displaying riding target display information preset by the user on the screen in response to the riding target being identified.

19. The display device of claim 15, wherein the operation of displaying of the riding target display information preset by the user on the screen includes an operation of displaying a notification message including at least portion of profile information of the riding target registered by the user on the screen.

20. The display device of claim 12, wherein the operation of displaying of the contents related to the riding target on the screen of the display device includes:
an operation of transmitting arrival notification information to a terminal of the user in response to the riding target being identified; and
an operation of transmitting riding notification information to the terminal of the user in response to the riding of the riding target being completed.
